(19) United States
(12) Patent Application Publication
(10) Pub. No.: US 2023/0223223 A1
(43) Pub. Date: Jul. 13, 2023

(54) ELECTROMAGNETIC CONTACTOR

(71) Applicant: FUJI ELECTRIC FA COMPONENTS & SYSTEMS CO., LTD., Saitama (JP)

(72) Inventors: Mitsuya ITOU, Saitama (JP); Kouetsu TAKAYA, Saitama (JP); Shouta KIKUCHI, Saitama (JP)

(21) Appl. No.: 18/174,990

(22) Filed: Feb. 27, 2023

Related U.S. Application Data
(63) Continuation of application No. PCT/JP2022/021813, filed on May 27, 2022.

(30) Foreign Application Priority Data
Jul. 5, 2021 (JP) 2021-111651

(51) Int. Cl. H01H 33/18; H01H 50/54

(52) U.S. Cl. CPC H01H 33/18; H01H 50/546

(57) ABSTRACT

An electromagnetic contactor includes a stationary contact element including a stationary contact, a movable contact element including a movable contact configured to be able to contact and separate from the stationary contact, an arc-extinguishing chamber that contains a contact portion that includes the stationary contact and the movable contact, and an arc runner provided in the arc-extinguishing chamber. The arc-extinguishing chamber includes an insulating wall portion that is situated beside the stationary contact element in a first direction that is a width direction of the stationary contact element. The arc runner is situated beside the contact portion in a second direction that is perpendicular to the first direction.

### CROSS-REFERENCE TO RELATED APPLICATIONS

The present application is a continuation application of International Application No. PCT/JP2022/021813, filed on May 27, 2022 and designating the U.S., which is based upon and claims priority to Japanese Patent Application No. 2021-111651, filed on Jul. 5, 2021. The entire contents of these applications are incorporated herein by reference.

### BACKGROUND OF THE INVENTION

### 1. Field of the Invention

The present disclosure relates to electromagnetic contactors.

### 2. Description of the Related Art

Patent Document 1 listed below discloses an arc-extinguishing grid having a shape (U-shape) like a wall that encloses a stationary contact and a movable contact in an electromagnetic contactor. Further, in conventional electromagnetic contactors, an arc runner is used to protect an insulating wall portion of an arc chamber from an arc.

However, in a similar manner to the arc-extinguishing grid described above, conventional arc runners have a shape (U-shape) like a wall that encloses a contact portion of a stationary contact and a movable contact. Thus, it is difficult to reduce the size of the arc-extinguishing chamber that contains the arc runner.

### RELATED-ART DOCUMENTS

### Patent Documents

[Patent Document 1] Japanese Patent Application Publication Laid-Open No. 11-162319

### SUMMARY OF THE INVENTION

The electromagnetic contactor according to an embodiment includes a stationary contact element including a stationary contact; a movable contact element including a movable contact configured to be able to contact and separate from the stationary contact; an arc-extinguishing chamber that contains a contact portion that includes the stationary contact and the movable contact; and an arc runner provided in the arc-extinguishing chamber. The arc-extinguishing chamber includes an insulating wall portion such that the insulating wall portion is situated beside the stationary contact element in a first direction that is a width direction of the stationary contact element. The arc runner is situated beside the contact portion in a second direction that is perpendicular to the first direction.

According to an embodiment, it is possible to reduce the size of the arc-extinguishing chamber while enhancing the protective performance with respect to the insulating wall portion of the arc-extinguishing chamber.

### BRIEF DESCRIPTION OF THE DRAWINGS

FIG. 1 is a cross-sectional view of an electromagnetic contactor according to the embodiment;

FIG. 2A is a perspective view of a first stationary contact element included in the electromagnetic contactor according to the first example;

FIG. 2B is a perspective view of the first stationary contact element included in the electromagnetic contactor according to the first example;

FIG. 3 is a plan view of a portion of a contact mechanism included in the electromagnetic contactor according to the first example;

FIG. 4 is a side view of the portion of the contact mechanism included in the electromagnetic contactor according to the first example;

FIG. 5 is a view for explaining the heat dissipation effect of an arc runner included in the electromagnetic contactor according to the first example;

FIG. 6A is a perspective view of the first stationary contact element included in the electromagnetic contactor according to the second example;

FIG. 6B is a perspective view of the first stationary contact element included in the electromagnetic contactor according to the second example;

FIG. 7A is a perspective view of the first stationary contact element included in the electromagnetic contactor according to the third example;

FIG. 7B is a perspective view of the first stationary contact element included in the electromagnetic contactor according to the third example;

FIG. 8 is a perspective view of the first stationary contact element included in the electromagnetic contactor according to the fourth example;

FIG. 9A is a perspective view of the first stationary contact element included in the electromagnetic contactor according to the fifth example;

FIG. 9B is a perspective view of the first stationary contact element included in the electromagnetic contactor according to the fifth example;

FIG. 10 is a perspective view of the first stationary contact element included in the electromagnetic contactor according to the sixth example;

FIG. 11 is a perspective view of an upper housing and an arc-extinguishing cover included in the electromagnetic contactor according to the sixth example; and

FIG. 12 is a partially enlarged cross-sectional view illustrating the press-fitted state of a first arc runner in the electromagnetic contactor according to the sixth example.

### DESCRIPTION OF THE EMBODIMENTS

An embodiment will be described hereinafter with reference to the accompanying drawings.

(Configuration of Electromagnetic Contactor 100)

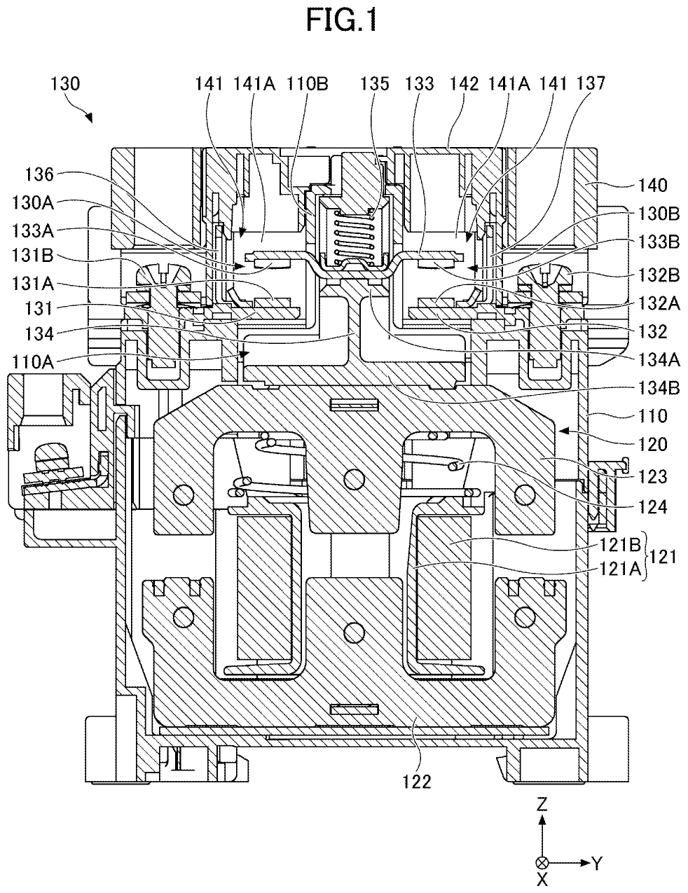

FIG. 1 is a cross-sectional view of an electromagnetic contactor 100 according to the embodiment. As illustrated in FIG. 1, the electromagnetic contactor 100 includes a case 110, an electromagnet 120, a contact mechanism 130, and an upper housing 140. For the sake of descriptive convenience hereinafter, the direction of movement of a movable contact element 133 is in the up-down direction (Z-axis direction), the long direction of the movable contact element 133 is in the left-right direction (Y-axis direction), and the short direction of the movable contact element 133 is in the front-rear direction (X-axis direction). Further, “the first direction” will refer to the front-rear direction (X-axis direction), and “the second direction” will refer to the left-right direction (Y-axis direction).

<Case 110>

The case 110 is a hollow component such as a container. For example, the case 110 is made of an insulating material such as a synthetic resin. An opening 110A is famed at the center of the upper surface of the case 110. A connecting member 134 is provided inside the opening 110A.

<Electromagnet 120>

The electromagnet 120 is provided inside the case 110. The electromagnet 120 generates magnetic force to move the movable contact element 133 up and down. The electromagnet 120 includes an electromagnetic coil 121, a stationary core 122, a movable core 123, and a coil spring 124.

The electromagnetic coil 121 includes a spool 121A and an excitation coil 121B. The excitation coil 121B is famed by winding a coil wire in multiple layers around a cylindrical portion of the spool 121A, and has a cylindrical shape that surrounds the cylindrical portion of the spool 121A.

In the case 110, the stationary core 122 and the movable core 123 are arranged to face each other vertically with the electromagnetic coil 121 provided therebetween. The stationary core 122 is provided in a stationary manner on the lower side (−Z-axis side) of the electromagnet 120. The movable core 123 is provided on the upper side (+Z-axis side) of the electromagnet 120 so as to be movable in the up-down direction (Z-axis direction). For example, the stationary core 122 and the movable core 123 are made of iron.

The coil spring 124 is provided between the movable core 123 and the electromagnetic coil 121 so as to be able to expand and contract in the up-down direction (Z-axis direction). The coil spring 124 biases the movable core 123 upward (in the +Z-axis direction).

<Contact Mechanism 130>

The contact mechanism 130 is provided on the upper side of the case 110. The contact mechanism 130 includes a first stationary contact element 131, a second stationary contact element 132, the movable contact element 133, the connecting member 134, a coil spring 135, a first arc runner 136, and a second arc runner 137.

The first stationary contact element 131 is a horizontal plate-shaped component with electrical conductivity. The first stationary contact element 131 is provided closer to the left side (−Y-axis side) with respect to the center of the contact mechanism 130 in the left-right direction (Y-axis direction). The first stationary contact element 131 is an elongated member that extends in the left-right direction (Y-axis direction). A first stationary contact 131A is provided on the upper surface of a tip portion (+Y-axis-side end portion) of the first stationary contact element 131. Further, an end portion (−Y-axis-side end portion) of the first stationary contact element 131 is attached to the upper surface of the case 110 by a screw 131B that is passed through the first stationary contact element 131. The first stationary contact element 131 is connected to a first line (illustration omitted) that extends outside from the first stationary contact element 131.

The second stationary contact element 132 is a horizontal plate-shaped component with electrical conductivity. The second stationary contact element 132 is provided closer to the right side (+Y-axis side) with respect to the center of the contact mechanism 130 in the left-right direction (Y-axis direction). Further, the second stationary contact element 132 is positioned at the same height as the first stationary contact element 131. The second stationary contact element 132 is an elongated member that extends in the left-right direction (Y-axis direction). A second stationary contact 132A is provided on the upper surface of a tip portion (−Y-axis-side end portion) of the second stationary contact element 132. Further, an end portion (+Y-axis-side end portion) of the second stationary contact element 132 is attached to the upper surface of the case 110 by a screw 132B that is passed through the second stationary contact element 132. The second stationary contact element 132 is connected to a second line (illustration omitted) that is led out externally from the second stationary contact element 132.

The movable contact element 133 is a horizontal plate-shaped component with electrical conductivity. The movable contact element 133 is provided such that the movable contact element 133 is at the center of the contact mechanism 130 in the left-right direction (Y-axis direction) and is on the upper side (+Z-axis side) of the first stationary contact element 131 and the second stationary contact element 132 in the up-down direction (Z-axis direction). The movable contact element 133 is an elongated member extending in the left-right direction (Y-axis direction). A first movable contact 133A is provided on the lower surface of a left end portion (−Y-axis-side end portion) of the movable contact element 133. The first movable contact 133A faces the first stationary contact 131A and is configured to be able to contact and separate from the first stationary contact 131A. A second movable contact 133B is provided on the lower surface of a right end portion (+Y-axis-side end portion) of the movable contact element 133. The second movable contact 133B faces the second stationary contact 132A and is configured to be able to contact and separate from the second stationary contact 132A.

The connecting member 134 is a component configured to connect the movable contact element 133 to the movable core 123 such that the movable contact element 133 can move along the up-down direction (Z-axis direction) together with the movable core 123. The lower portion of the connecting member 134 is provided in the opening 110A, which is famed in the center of the upper surface of the case 110. The upper portion of the connecting member 134 is provided in the inner space of a support member 110B that is provided to protrude upward from the center of the upper surface of the case 110. The upper portion of the connecting member 134 holds the center portion of the movable contact element 133 and the coil spring 135. In the upper portion of the connecting member 134, plate-shaped first connecting portions 134A, each of which is provided on the lower side of the center portion of the movable contact element 133, push the center portion of the movable contact element 133 upward by integrally moving upward with the connecting member 134 in response to the electromagnetic contactor 100 being switched off. A plate-shaped second connecting portion 134B provided on the lower portion of the connecting member 134 is fixed to the upper surface of the center portion of the movable core 123 by a given fixing means.

In the inner space of the support member 110B provided protruding upward from the center of the upper surface of the case 110, the coil spring 135 is held together with the center portion of the movable contact element 133 in a space famed above the connecting member 134. The coil spring 135 is provided on the upper side of the center portion of the movable contact element 133 in the above-described space of the connecting member 134. The coil spring 135 is able to contract and expand in the up-down direction (Z-axis direction). The coil spring 135 urges the center portion of the movable contact element 133 downward (in the −Z-axis direction). The coil spring 135 moves downward together with the connecting member 134 to push the movable contact element 133 against the first stationary contact element 131 and the second stationary contact element 132 in response to the electromagnetic contactor 100 being switched on.

The first arc runner 136 is provided to stand on the upper surface of the first stationary contact element 131, is closer to the outer side (−Y-axis side) with respect to the first stationary contact 131A, and is fixed to the upper surface of the first stationary contact element 131 by a given fixing means. The first arc runner 136 is made of a plate-shaped magnetic member (for example, a metal plate) extending in the up-down direction (Z-axis direction), and has a shape (that is, an L-shape) in which the lower portion of the magnetic member has been bent inward (+Y-axis side) at a right angle. The first arc runner 136 is provided to protect an insulating wall portion 141A of the upper housing 140 by guiding an arc generated between the first stationary contact 131A and the first movable contact 133A to the first arc runner 136. Note that although it is preferable for the first arc runner 136 to be made of a magnetic material, the material is not limited to this. A material (for example, a metal) other than the material comprising the magnetic member may be used as long as the material has at least an arc guiding effect.

The second arc runner 137 is provided to stand on the upper surface of second stationary contact element 132, is closer to the outer side (+Y-axis side) with respect to the second stationary contact 132A, and is fixed to the upper surface of the second stationary contact element 132 by a given fixing means. The second arc runner 137 is made of a plate-shaped magnetic member (for example, a metal plate) extending in the up-down direction (Z-axis direction), and has a shape (that is, an L-shape) in which the lower portion of the magnetic member is bent inwards (−Y-axis side) at a right angle. The second arc runner 137 is provided to protect the insulating wall portion 141A of the upper housing 140 by guiding an arc generated between the second stationary contact 132A and the second movable contact 133B to the second arc runner 137. Note that although it is preferable for the second arc runner 137 to be made of a magnetic material, the material is not limited to this. A material (for example, a metal) other than the material comprising the magnetic member may be used as long as the material has at least an arc guiding effect.

<Upper Housing 140>

The upper housing 140 is provided on the upper portion of the case 110 so as to surround the contact mechanism 130. The upper housing 140 is made of, for example, a resin material with insulating properties. The upper housing 140 includes a pair of left and right arc-extinguishing chambers 141. The left (−Y-axis side) arc-extinguishing chamber 141 includes a first contact portion 130A and the first arc runner 136. The first contact portion 130A indicates a pair composed of the first stationary contact 131A and the first movable contact 133A. The right (+Y-axis side) arc-extinguishing chamber 141 includes a second contact portion 130B and the second arc runner 137. The second contact portion 130B indicates a pair composed of the second stationary contact 132A and the second movable contact 133B. Each arc-extinguishing chamber 141 includes the insulating wall portion 141A between itself and another neighboring arc-extinguishing chamber 141 in the front-rear direction (X-axis direction). Further, the lateral sides in the left-right direction (Y-axis direction) and the upper side of each arc-extinguishing chamber 141 are closed by an arc-extinguishing cover 142 attached to the upper housing 140.

(Operation of Electromagnetic Contactor 100)

In the electromagnetic contactor 100 according to the embodiment, the movable core 123 is urged upward (in the +Z-axis direction) by the biasing force of the coil spring 124 when the excitation coil 121B is not energized. As a result, the movable contact element 133 connected to the movable core 123 through the connecting member 134 moves upward (in the +Z-axis direction) by being pushed up by the first connecting portions 134A of the connecting member 134, thus creating a state where the movable contact element 133 is separated upward (in the +Z-axis direction) from the first stationary contact element 131 and the second stationary contact element 132. Hence, the electromagnetic contactor 100 changes to a state (that is, a switched-off state) where the first stationary contact element 131 and the second stationary contact element 132 are not electrically conductive as illustrated in FIG. 1.

In contrast, in the electromagnetic contactor 100 according to the embodiment, a magnetic attraction force that overcomes the biasing force of the coil spring 124 is generated between the stationary core 122 and the movable core 123 when the excitation coil 121B is energized. This magnetic attraction force causes the movable core 123 to move downward (in the −Z-axis direction). At this time, the movable contact element 133 connected to the movable core 123 through the connecting member 134 moves downward (in the −Z-axis direction) by receiving the biasing force from the coil spring 135 that moves downward (in the −Z-axis direction) together with the connecting member 134. Hence, each of the first movable contact 133A and the second movable contact 133B provided on the movable contact element 133 contacts the corresponding one of the first stationary contact 131A provided on the first stationary contact element 131 and the second stationary contact 132A provided on the second stationary contact element 132. The contact pressure at this time is increased by the biasing force of the coil spring 135. As a result, the electromagnetic contactor 100 changes to a state (that is, a switched-on state) where the first stationary contact element 131 and the second stationary contact element 132 are electrically conductive.

Subsequently, in the electromagnetic contactor 100 according to the embodiment, when the energization of the excitation coil 121B is stopped, the movable core 123 is urged upward (in the +Z-axis direction) by the biasing force of the coil spring 124. As a result, the movable contact element 133 that is connected to the movable core 123 through the connecting member 134 moves upward (in the +Z-axis direction) by being pushed up by the first connecting portion 134A of the connecting member 134, thus creating a state where the movable contact element 133 is separated upward (in the +Z-axis direction) from the first stationary contact element 131 and the second stationary contact element 132. Hence, the electromagnetic contactor 100 changes to a state (that is, the switched-off state) where the first stationary contact element 131 and the second stationary contact element 132 are not electrically conductive as illustrated in FIG. 1.

Note that in the electromagnetic contactor 100 according to the embodiment, the first arc runner 136 and the second arc runner 137 are provided near the first contact portion 130A and the second contact portion 130B, respectively. Hence, when the electromagnetic contactor 100 is switched between the switched-on state and the switched-off state, the insulating wall portion 141A of the upper housing 140 can be protected by guiding the arcs that are generated in the first contact portion 130A and the second contact portion 130B to the first arc runner 136 and the second arc runner 137.

### First Example

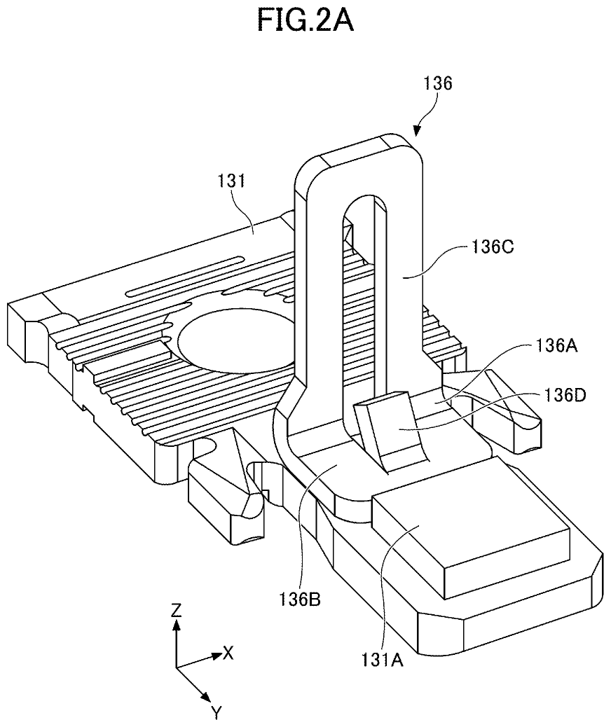

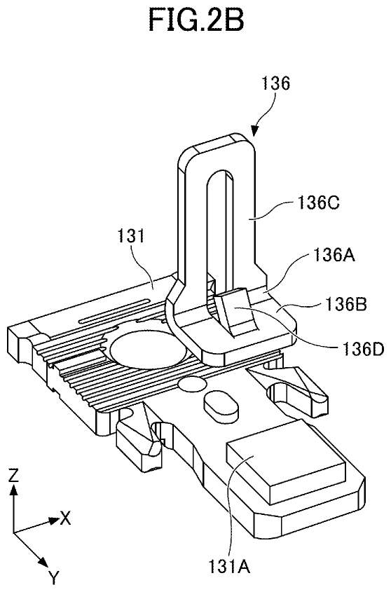

The first example of the electromagnetic contactor 100 according to the embodiment will be described hereinafter with reference to FIGS. 2A and 2B. FIGS. 2A and 2B each are a perspective view of the first stationary contact element 131 included in the electromagnetic contactor 100 according to the first example. FIG. 2A illustrates the first stationary contact element 131 with the first arc runner 136 attached. FIG. 2B illustrates the first stationary contact element 131 without the first arc runner 136 attached.

Although the configuration of the first arc runner 136 will be exemplified hereinafter, note that the configuration of the second arc runner 137, apart from being symmetrical to the first arc runner 136, is identical to the configuration of the first arc runner 136.

As illustrated in FIGS. 2A and 2B, the first stationary contact element 131 is a plate-shaped component made of, for example, a metal plate, and has an elongated shape in which the left-right direction (Y-axis direction) is the long direction. As illustrated in FIGS. 2A and 2B, the first stationary contact 131A is provided on the upper surface of the tip portion in the left-right direction (Y-axis direction) of the first stationary contact element 131. Further, on the upper surface of the center portion of the first stationary contact element 131 in the left-right direction (Y-axis direction), the first arc runner 136 is provided standing adjacent to the first stationary contact 131A.

As illustrated in FIG. 2A, the first arc runner 136 has an L-shape that is bent at a bent portion (first bent portion) 136A. The first arc runner 136 includes a horizontal portion 136B, which is provided closer to one end (right side) with respect to the bent portion 136A, and a vertical portion 136C, which is provided closer to the other end (upper side) with respect to the bent portion 136A. The horizontal portion 136B is a plate-shaped portion that is horizontal to the upper surface of the first stationary contact element 131. The vertical portion 136C is a plate-shaped portion that is perpendicular to the upper surface of the first stationary contact element 131. As illustrated in FIG. 2A, the first arc runner 136 is provided such that the vertical portion 136C stands perpendicular to the upper surface of the first stationary contact element 131 by fixing the horizontal portion 136B to the upper surface of the first stationary contact element 131.

In the electromagnetic contactor 100 according to the first example, the first arc runner 136 is provided closer to the left side (−Y-axis side) with respect to the first stationary contact 131A, and the first arc runner 136 has a plate shape. That is, the first arc runner 136 does not include a side wall portion between the first contact portion 130A and the insulating wall portion 141A included in the arc-extinguishing chamber 141. As a result, in the electromagnetic contactor 100 according to the first example, the insulating wall portion 141A of the upper housing 140 can be brought closer to the first contact portion 130A. Hence, according to the electromagnetic contactor 100 of the first example, it is possible to reduce the size of the arc-extinguishing chamber 141 while increasing the protective performance with respect the insulating wall portion 141A of the arc-extinguishing chamber 141.

Further, in the electromagnetic contactor 100 according to the first example, the first arc runner 136 is bent in an L-shape and includes the horizontal portion 136B. Hence, in regard to the electromagnetic contactor 100 according to the first example, it is possible to restrain the manufacturing cost of the first arc runner 136 and to easily fix the first arc runner 136 to the upper surface of the first stationary contact element 131 by the horizontal portion 136B.

Further, in the electromagnetic contactor 100 according to the first example, the horizontal portion 136B of the first arc runner 136 is welded to the upper surface of the first stationary contact element 131. As a result, in the electromagnetic contactor 100 according to the first example, the horizontal portion 136B of the first arc runner 136 can be easily and reliably fixed to the upper surface of the first stationary contact element 131.

Further, in the electromagnetic contactor 100 according to the first example, the width of the first arc runner 136 in the front-rear direction (X-axis direction) may be narrower or equal to the width of the first stationary contact element 131 in the front-rear direction (X-axis direction). For example, in the first example, the width of the first arc runner 136 in the front rear direction (X-axis direction) is the same as the width of the first stationary contact element in the front-rear direction (X-axis direction). As a result, in the electromagnetic contactor 100 according to the first example, the first arc runner 136 can be installed without protruding from the first stationary contact element 131, thus allowing further reduction in the size of the arc-extinguishing chamber 141. In addition, since the size of the first arc runner 136 can be reduced in the electromagnetic contactor 100 according to the first example, the cost of the first arc runner 136 can be reduced.

Further, in the electromagnetic contactor 100 according to the first example, the first arc runner 136 includes a protrusion 136D, which protrudes from the upper surface of the horizontal portion 136B, in the center of the upper surface (the first-contact-portion-side surface) of the horizontal portion 136B in the front-rear direction (X-axis direction). As a result, in the electromagnetic contactor 100 according to the first example, an arc generated in the first contact portion 130A can be actively guided to the center portion of the first arc runner 136 in the front-rear direction (X-axis direction). Hence, in the electromagnetic contactor 100 according to the first example, the transfer of an arc generated in the first contact portion 130A to the insulating wall portion 141A of the arc-extinguishing chamber 141 can be suppressed.

Note that in the electromagnetic contactor 100 according to the first example, the protrusion 136D is a bent portion (second bent portion) of the horizontal portion 136B. Hence, in the electromagnetic contactor 100 according to the first example, the protrusion 136D can be provided easily on the first arc runner 136.

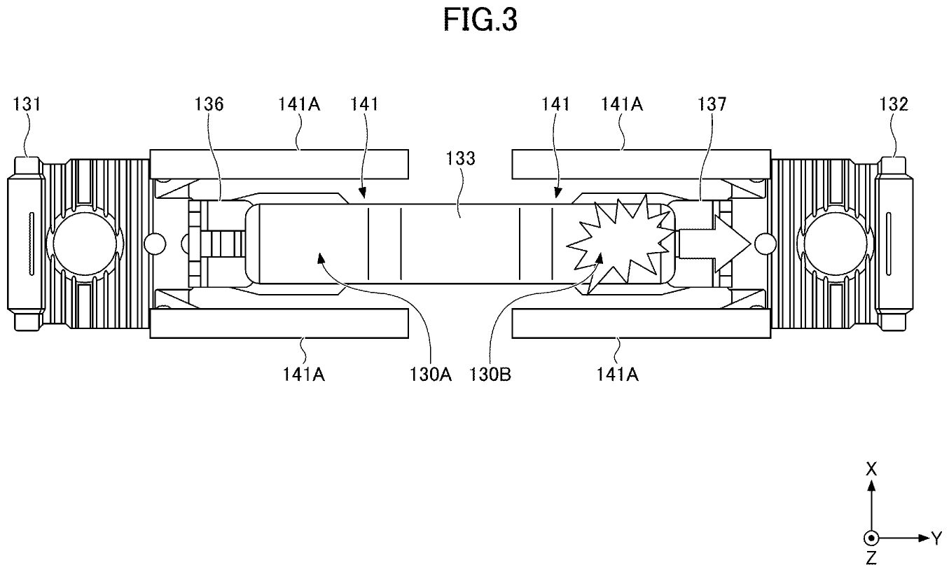

FIG. 3 is a plan view of a portion of the contact mechanism 130 included in the electromagnetic contactor 100 according to the first example.

As illustrated in FIG. 3, in the electromagnetic contactor 100 according to the first example, the first arc runner 136 is provided closer to the left side (−Y-axis side) with respect to the first contact portion 130A, and the first arc runner 136 has a plate shape. That is, the first arc runner 136 does not include a side wall portion between the first contact portion 130A and the insulating wall portion 141A of the arc-extinguishing chamber 141. Hence, in the electromagnetic contactor 100 according to the first example, the insulating wall portion 141A included in the arc-extinguishing chamber 141 of the upper housing 140 can be brought closer to the first contact portion 130A in the front-rear direction (X-axis direction).

In particular, as illustrated in FIG. 3, the width of the first arc runner 136 in the front-rear direction (X-axis direction) is equal to the width of the first stationary contact element 131 (the installation portion of the first arc runner 136) in the front-rear direction (X-axis direction). As a result, in the electromagnetic contactor 100 according to the first example, the insulating wall portion 141A can be brought even closer to the first contact portion 130A.

In a similar manner, as illustrated in FIG. 3, in the electromagnetic contactor 100 according to the first example, the second arc runner 137 is provided closer to the right side (+Y-axis side) with respect to the second contact portion 130B, and the second arc runner 137 has a plate shape. That is, the second arc runner 137 does not include a side wall portion between the second contact portion 130B and the insulating wall portion 141A of the arc-extinguishing chamber 141. Hence, in the electromagnetic contactor 100 according to the first example, the insulating wall portion 141A included in the arc-extinguishing chamber 141 of the upper housing 140 can be brought closer to the second contact portion 130B in the front-rear direction (X-axis direction).

In particular, as illustrated in FIG. 3, the width of the second arc runner 137 in the front-rear direction (X-axis direction) is equal to the width of the second stationary contact element 132 (the installation portion of the second arc runner 137) in the front-rear direction (X-axis direction). As a result, in the electromagnetic contactor 100 according to the first example, the insulating wall portion 141A can be brought even closer to the second contact portion 130B.

(Guiding Effect of Arc Runner)

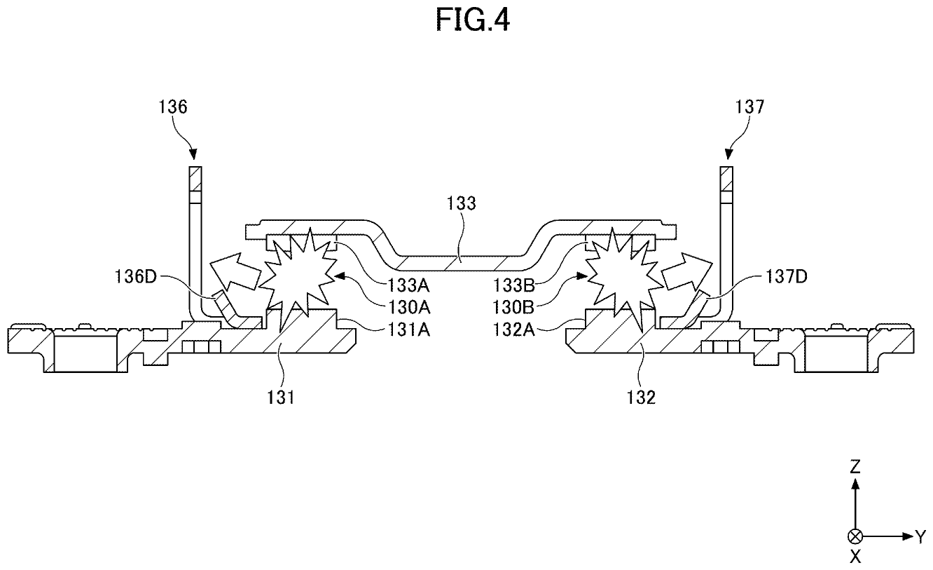

FIG. 4 is a side view of a portion of the contact mechanism 130 included in the electromagnetic contactor 100 according to the first example.

As illustrated in FIG. 4, in the electromagnetic contactor 100 according to the first example, the first arc runner 136 is provided closer to the left side (−Y-axis side) with respect to the first contact portion 130A, and does not include a side wall portion. Hence, in the electromagnetic contactor 100 according to the first example, an arc generated in the first contact portion 130A can be guided to the left side (−Y-axis side) of the first contact portion 130A. Particularly, in the electromagnetic contactor 100 according to the first example, the first arc runner 136 includes the protrusion 136D. Thus, an arc generated in the first contact portion 130A can be even more actively guided to the left side (−Y-axis side) with respect to the first contact portion 130A. Hence, in the electromagnetic contactor 100 according to the first example, it is possible to suppress the transfer of an arc that has been generated in the first contact portion 130A to the insulating wall portion 141A of the arc-extinguishing chamber 141, which is provided in the front-rear direction (X-axis direction) of the first contact portion 130A. Therefore, it is possible to reduce damage to the insulating wall portion 141A.

In a similar manner, as illustrated in FIG. 4, in the electromagnetic contactor 100 according to the first example, the second arc runner 137 is provided closer to the right side (+Y-axis side) with respect to the second contact portion 130B, and does not include a side wall portion. Hence, in the electromagnetic contactor 100 according to the first example, an arc generated in the second contact portion 130B can be guided to the right side (+Y-axis side) with respect to the second contact portion 130B. Particularly, in the electromagnetic contactor 100 according to the first example, the second arc runner 137 includes a protrusion 137D. Thus, an arc generated in the second contact portion 130B can be actively guided to the right side (+Y-axis side) with respect to the second contact portion 130B. Hence, in the electromagnetic contactor 100 according to the first example, it is possible to suppress the transfer of an arc that has been generated in the second contact portion 130B to the insulating wall portion 141A of the arc-extinguishing chamber 141 provided in the front-rear direction (X-axis direction) of the second contact portion 130B. Therefore, it is possible to reduce damage to the insulating wall portion 141A.

(Heat Dissipation Effect of Arc Runner)

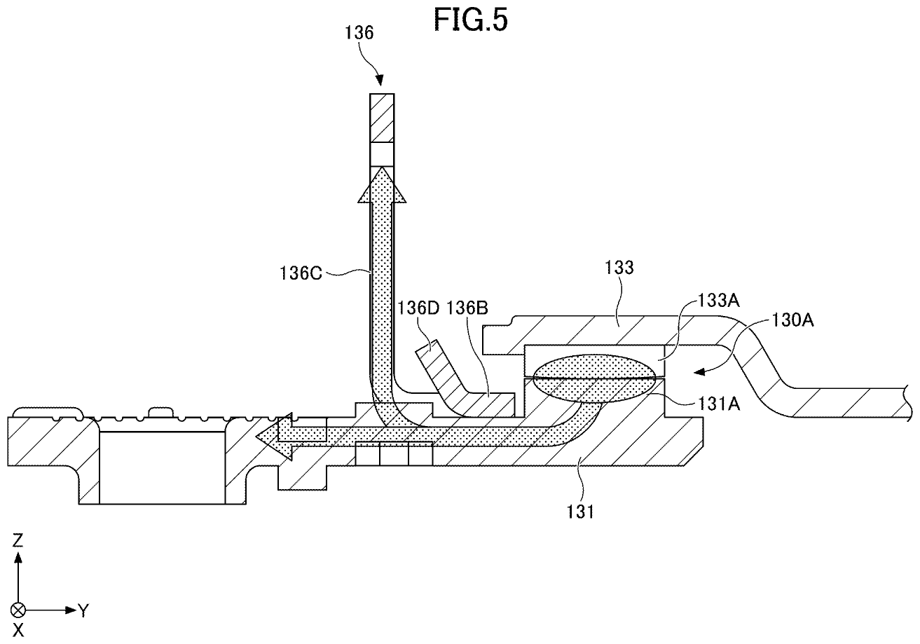

FIG. 5 is a view for explaining the heat dissipation effect of each arc runner included in the electromagnetic contactor 100 according to the first example. As illustrated in FIG. 5, the heat generated due to contact resistance at the first contact portion 130A is transferred from the tip portion to the end portion of the first stationary contact element 131.

As illustrated in FIG. 5, in the electromagnetic contactor 100 according to the first example, the first arc runner 136 is provided in the center of the upper surface of the first stationary contact element 131 in the left-right direction (Y-axis direction). Hence, in the electromagnetic contactor 100 according to the first example, the heat transferred through the first stationary contact element 131 can be dispersed to the first arc runner 136 and be dissipated from the first arc runner 136. That is, the first arc runner 136 functions as a heat sink that dissipates heat generated in the first contact portion 130A.

Particularly, in the electromagnetic contactor 100 according to the first example, the first arc runner 136 is in surface contact with the upper surface of the first stationary contact element 131. Hence, the heat transferred through the first stationary contact element 131 can be efficiently dispersed to the first arc runner 136, and thus the heat dissipation effect of the first arc runner 136 can be enhanced.

Further, in the electromagnetic contactor 100 according to the first example, since the vertical portion 136C of the first arc runner 136 has a relatively large area of contact with the external air, the heat dissipation effect of the first arc runner 136 can be further enhanced.

Note that, in the electromagnetic contactor 100 according to the first example, the second arc runner 137 has the same configuration as the first arc runner 136. Hence, the second arc runner 137 is able to efficiently dissipate the heat that is generated due to contact resistance at the second contact portion 130B.

### Second Example

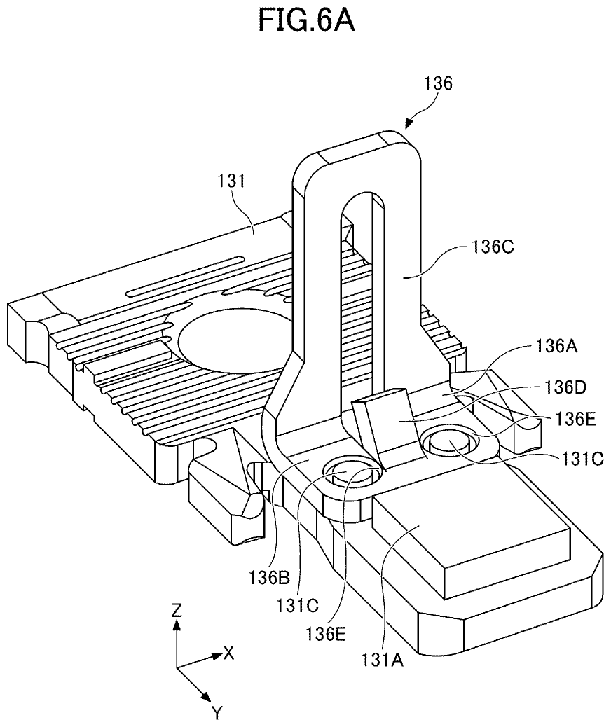

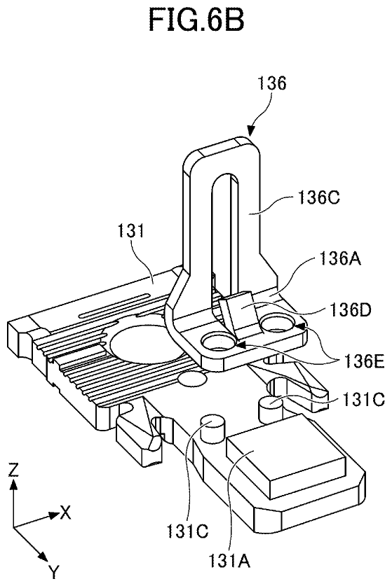

The second example of the electromagnetic contactor 100 according to the embodiment will be described hereinafter with reference to FIGS. 6A and 6B. FIGS. 6A and 6B each are a perspective view of the first stationary contact element 131 included in the electromagnetic contactor 100 according to the second example. FIG. 6A illustrates the first stationary contact element 131 with the first arc runner 136 attached. FIG. 6B illustrates the first stationary contact element 131 without the first arc runner 136 attached.

In the electromagnetic contactor 100 according to the second example, the horizontal portion 136B of the first arc runner 136 is staked to the upper surface of the first stationary contact element 131. As a result, in the electromagnetic contactor 100 according to the second embodiment, the horizontal portion 136B of the first arc runner 136 can be easily and reliably fixed to the upper surface of the first stationary contact element 131.

More specifically, in the horizontal portion 136B of the first arc runner 136, two circular through holes 136E are famed side by side in the front-rear direction (X-axis direction) with the protrusion 136D interposed therebetween. Further, two cylindrical protrusions 131C are famed side by side, in the front-rear direction (X-axis direction), on the upper surface of the first stationary contact element 131.

Each of the two protrusions 131C is fitted into the corresponding one of the two through holes 136E. Subsequently, each of the two protrusions 131C is staked by applying pressure onto each of the protrusions 131C from above. That is, the diameter of the upper end portion of each of the two protrusions 131C becomes larger than the diameter of the corresponding one of the through holes 136E. As a result, the horizontal portion 136B of the first arc runner 136 is reliably fixed to the upper surface of the first stationary contact element 131.

### Third Example

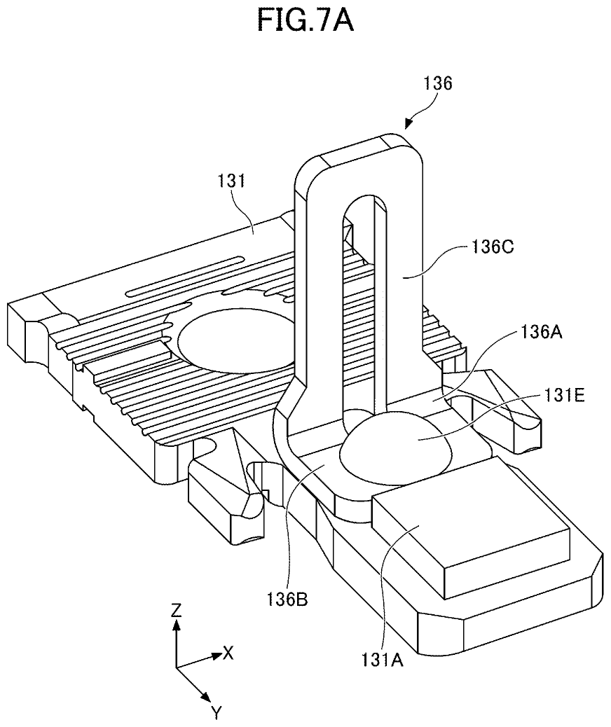

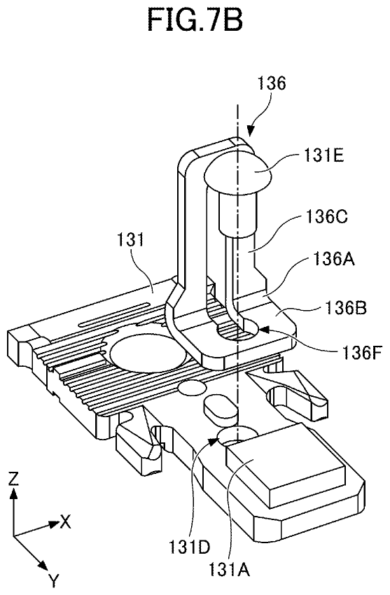

The third example of the electromagnetic contactor 100 according to the embodiment will be described hereinafter with reference to FIGS. 7A and 7B. FIGS. 7A and 7B each are a perspective view of the first stationary contact element 131 included in the electromagnetic contactor 100 according to the third example. FIG. 7A illustrates the first stationary contact element 131 with the first arc runner 136 attached. FIG. 7B illustrates the first stationary contact element 131 without the first arc runner 136 attached.

In the electromagnetic contactor 100 according to the third example, the horizontal portion 136B of the first arc runner 136 is fixed to the upper surface of the first stationary contact element 131 by a rivet 131E. Hence, in the electromagnetic contactor 100 according to the third example, the horizontal portion 136B of the first arc runner 136 can be easily and reliably fixed to the upper surface of the first stationary contact element 131.

More specifically, a circular through hole 136F is famed in the center of the horizontal portion 136B of the first arc runner 136. A circular through hole 131D is famed in a position on the first stationary contact element 131 that overlaps with the through hole 136F.

The rivet 131E is passed through the through hole 136F and the through hole 131D, and a pressure is applied to the rivet 131E from below to stake the rivet 131E. Hence, the diameter of the lower end portion of the rivet 131E becomes larger than the diameter of the through hole 131D. As result, the horizontal portion 136B of the first arc runner 136 can be reliably fixed to the upper surface of the first stationary contact element 131.

### Fourth Example

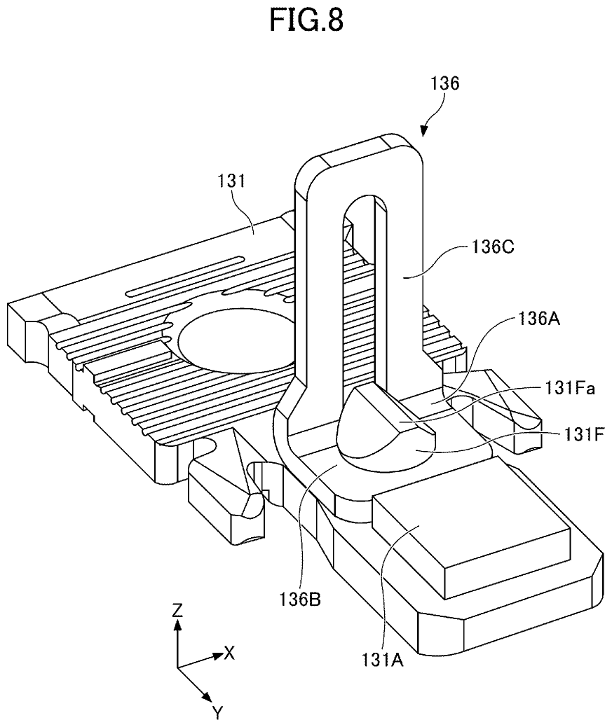

The fourth example of the electromagnetic contactor 100 according to the embodiment will be described hereinafter with reference to FIG. 8. FIG. 8 is a perspective view of the first stationary contact element 131 included in the electromagnetic contactor 100 according to the fourth example. The electromagnetic contactor 100 according to the fourth example differs from the electromagnetic contactor 100 according to the third example in that a rivet 131F is used instead of the rivet 131E.

The surface of the head of the rivet 131E, illustrated in FIGS. 7A and 7B, is curved. In contrast, the head of the rivet 131F illustrated in FIG. 8 includes an edge portion 131Fa with a pointed tip. Particularly, in the example illustrated in FIG. 8, the edge portion 131Fa is famed linearly along the left-right direction (Y-axis direction).

As a result, in the electromagnetic contactor 100 according to the fourth example, an arc generated in the first contact portion 130A can be even more actively guided to the left side (−Y-axis side) with respect to the first contact portion 130A. Hence, in the electromagnetic contactor 100 according to the fourth example, it is possible to suppress the transfer of an arc that has been generated in the first contact portion 130A to the insulating wall portion 141A of the arc-extinguishing chamber 141 provided in the front-rear direction (X-axis direction) of the first contact portion 130A. Therefore, it is possible to reduce damage to the insulating wall portion 141A.

### Fifth Example

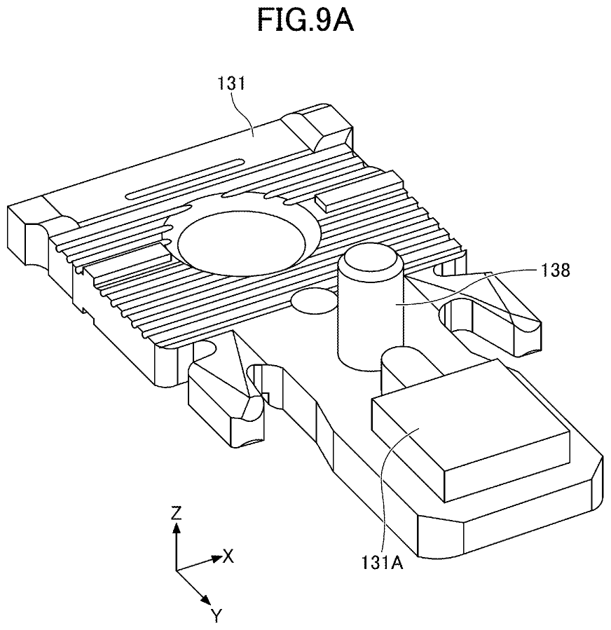

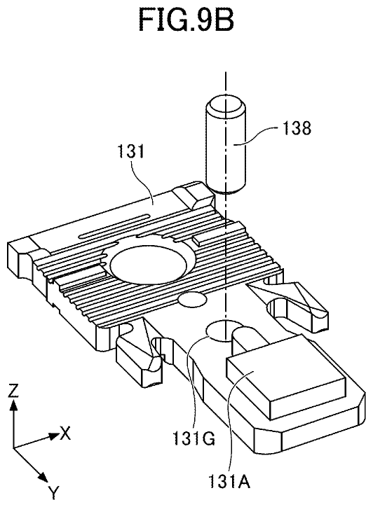

The fifth example of the electromagnetic contactor 100 according to the embodiment will be described hereinafter with reference to FIGS. 9A and 9B. FIGS. 9A and 9B each are a perspective view of the first stationary contact element 131 included in the electromagnetic contactor 100 according to the fifth example. FIG. 9A illustrates the first stationary contact element 131 with a first arc runner 138 attached. FIG. 9B illustrates the first stationary contact element 131 without the first arc runner 138 attached.

As illustrated in FIG. 9A, in the electromagnetic contactor 100 according to the fifth example, the first arc runner 138 is provided on the upper surface of the center portion of the first stationary contact element 131 in the left-right direction (Y-axis direction) so as to stand adjacent to the first stationary contact 131A.

As illustrated in FIGS. 9A and 9B, the first arc runner 138 is cylindrical and is perpendicular to the upper surface of the first stationary contact element 131. As illustrated in FIG. 9B, the first arc runner 138 is press-fitted into a circular through hole 131G, which is famed in the first stationary contact element 131, so as to stand perpendicular to the upper surface of the first stationary contact element 131.

In the electromagnetic contactor 100 according to the fifth example, an arc generated in the first contact portion 130A can be guided to the first arc runner 138 provided on the left side (−Y-axis side) with respect to the first contact portion 130A. Hence, the electromagnetic contactor 100 according to the fifth example, it is possible to suppress the transfer of an arc generated in the first contact portion 130A to the insulating wall portion 141A of the arc-extinguishing chamber 141 that is provided in the front-rear direction (X-axis direction) of the first contact portion 130A.

Further, since the electromagnetic contactor 100 according to the fifth example does not include a shielding object that blocks the space between the first contact portion 130A and the insulating wall portion 141A, the insulating wall portion 141A can be brought closer to the first contact portion 130A.

Furthermore, the electromagnetic contactor 100 according to the fifth example employs a relatively simple configuration in which the cylindrical first arc runner 138 is press-fitted into the through hole 131G of the first stationary contact element 131. Hence, the first arc runner 138 can be easily and reliably fixed to the upper surface of the first stationary contact element 131.

### Sixth Example

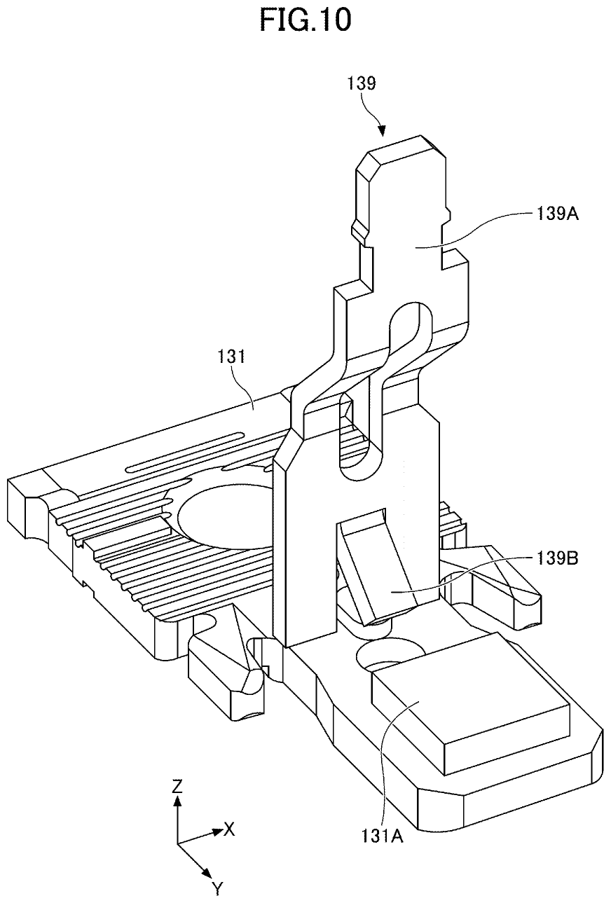

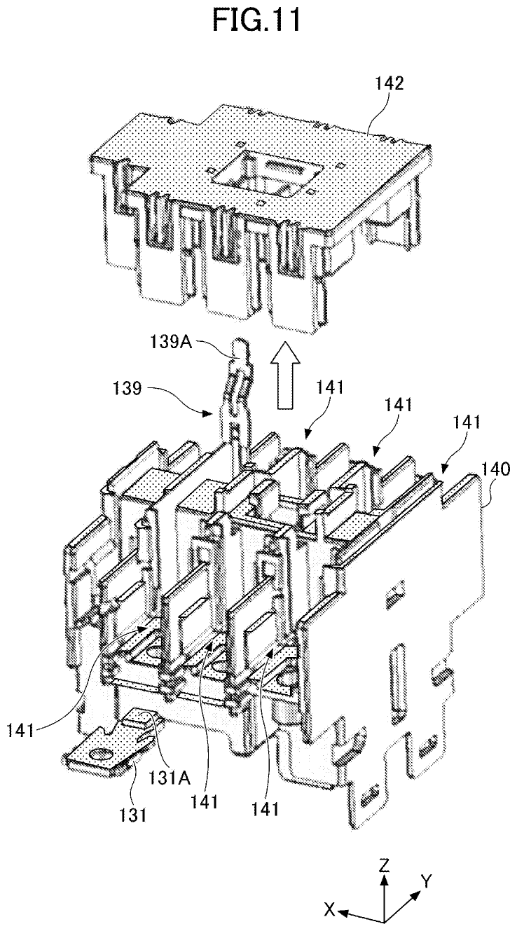

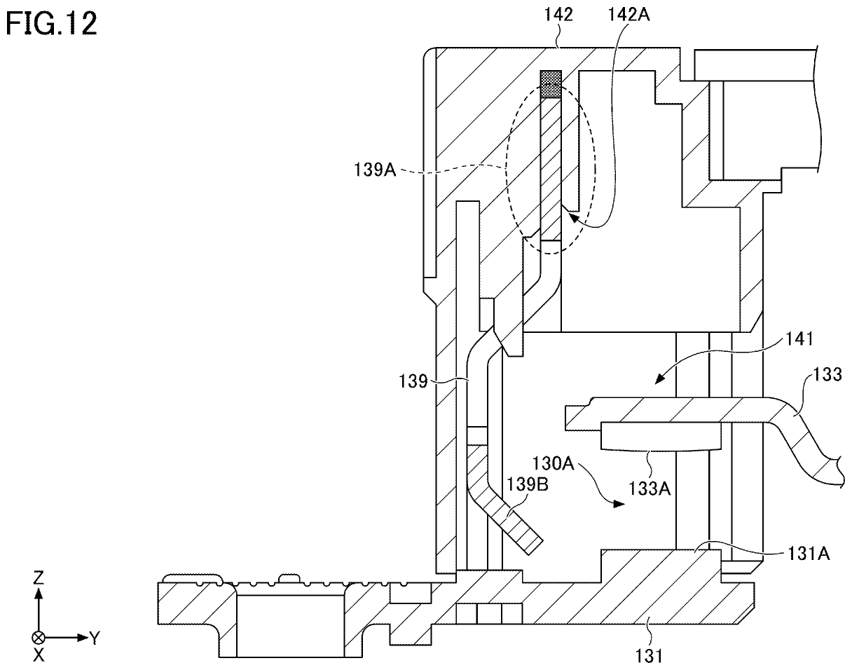

The sixth example of the electromagnetic contactor 100 according the embodiment will be described hereinafter with reference to FIGS. 10 to 12. FIG. 10 is a perspective view of the first stationary contact element 131 included in the electromagnetic contactor 100 according to the sixth example. FIG. 11 is a perspective view of the upper housing 140 and the arc-extinguishing cover 142 included in the electromagnetic contactor 100 according to the sixth example. FIG. 12 is a partially enlarged cross-sectional view illustrating the press-fitted state of a first arc runner 139 of the electromagnetic contactor 100 according to the sixth example.

As illustrated in FIG. 10, the first arc runner 139 included in the electromagnetic contactor 100 of the sixth example is a plate-shaped component extending in the up-down direction (Z-axis direction). As illustrated in FIG. 10, the first arc runner 139 is provided in a perpendicular posture with respect to the upper surface of the first stationary contact element 131. However, the first arc runner 139 is not fixed to the upper surface of the first stationary contact element 131. The upper portion of the first arc runner 139 is fixed to the arc-extinguishing cover 142.

More specifically, as illustrated in FIG. 10, the first arc runner 139 includes a plate-shaped press-fit portion 139A in its upper portion. As illustrated in FIGS. 11 and 12, the first arc runner 139 is fixed to the arc-extinguishing cover 142 by press-fitting the press-fit portion 139A into a press-fit port 142A, which is formed on the ceiling surface of the arc-extinguishing cover 142 (that is, the ceiling surface of the arc-extinguishing chamber 141).

Attaching the arc-extinguishing cover 142 to the upper housing 140 as illustrated in FIG. 12 allows the first arc runner 139 to be provided, in a perpendicular posture to the upper surface of the first stationary contact element 131, on the left side (−Y-axis side) of the first contact portion 130A in the arc-extinguishing chamber 141.

The electromagnetic contactor 100 according to the sixth example can guide an arc generated in the first contact portion 130A to the first arc runner 139 provided on the left side (−Y-axis side) with respect to the first contact portion 130A. Hence, in the electromagnetic contactor 100 according to the sixth example, it is possible to suppress the transfer of an arc generated in the first contact portion 130A to the insulating wall portion 141A of the arc-extinguishing chamber 141 that is provided in the front-rear direction (X-axis direction) of the first contact portion 130A.

Further, since the electromagnetic contactor 100 according to the sixth example does not include a shielding object that blocks the space between the first contact portion 130A and the insulating wall portion 141A, the insulating wall portion 141A can be brought closer to the first contact portion 130A.

Further, the electromagnetic contactor 100 according to the sixth example employs a relatively simple configuration in which the plate-shaped first arc runner 139 is press-fitted into the press-fit port 142A of the arc-extinguishing cover 142. Hence, the first arc runner 139, which is provided in a perpendicular posture with respect to the upper surface of the first stationary contact element 131, can be affixed easily and reliably.

Particularly, in the electromagnetic contactor 100 according to the sixth example, since the first arc runner 139 includes a protrusion 139B that is a bent portion (second bend portion) of the first arc runner 139, an arc generated in the first contact portion 130A can be even more actively guided to the left side (−Y-axis side) with respect to the first contact portion 130A.

Although the embodiments have been described above, the present disclosure is not limited to the particulars of the above-described embodiments, and various modifications and changes can be implemented within the scope of the subject matter as recited in the appended claims.

What is claimed is:

1. An electromagnetic contactor comprising:
a stationary contact element including a stationary contact;
a movable contact element including a movable contact configured to be able to contact and separate from the stationary contact;
an arc-extinguishing chamber that contains a contact portion that includes the stationary contact and the movable contact; and
an arc runner provided in the arc-extinguishing chamber,
wherein the arc-extinguishing chamber includes an insulating wall portion that is situated beside the stationary contact element in a first direction that is a width direction of the stationary contact element,
wherein the arc runner is situated beside the contact portion in a second direction that is perpendicular to the first direction,
wherein the arc runner is fixed to the stationary contact element in a state in which the arc runner stands on the stationary contact element,
wherein the arc runner has an L-shape that is bent at a bent portion, includes a plate-shaped horizontal portion provided closer to one end with respect to the bent portion, and includes a plate-shaped vertical portion provided closer to the other end with respect to the bent portion,
wherein the horizontal portion is fixed to a surface of the stationary contact element,
wherein the vertical portion is erected on the surface of the stationary contact element, and
wherein the arc runner includes, in a center of a contact-portion-side surface in the first direction, a protrusion protruding from the contact-portion-side surface.

2. The electromagnetic contactor according to claim 1, wherein a width of the arc runner in the first direction is narrower or equal to a width of the stationary contact element in the first direction.

3. The electromagnetic contactor according to claim 1, wherein the horizontal portion is welded to the surface of the stationary contact element.

4. The electromagnetic contactor according to claim 1, wherein the horizontal portion is staked to the surface of the stationary contact element.

5. The electromagnetic contactor according to claim 1, wherein the horizontal portion is fixed to the surface of the stationary contact element by a rivet.

6. An electromagnetic contactor comprising:
a stationary contact element including a stationary contact;
a movable contact element including a movable contact configured to be able to contact and separate from the stationary contact;
an arc-extinguishing chamber that contains a contact portion that includes the stationary contact and the movable contact; and
an arc runner provided in the arc-extinguishing chamber,
wherein the arc-extinguishing chamber includes an insulating wall portion situated beside the stationary contact element in a first direction that is a width direction of the stationary contact element,
wherein the arc runner is situated beside the contact portion in a second direction that is perpendicular to the first direction,
wherein the arc runner is fixed to the stationary contact element in a state in which the arc runner stands on the stationary contact element,
wherein the arc runner has an L-shape that is bent at a first bent portion, includes a plate-shaped horizontal portion provided closer to one end with respect to the first bent portion, and includes a plate-shaped vertical portion provided closer to the other end with respect to the first bent portion,
wherein the vertical portion is erected on the surface of the stationary contact element,
wherein the horizontal portion is fixed to the surface of the stationary contact element by a rivet, and
wherein the rivet includes an edge portion with a pointed tip on a surface of a head.

7. The electromagnetic contactor according to claim 6, wherein the arc runner includes, in a center of a contact-portion-side surface in the first direction, a protrusion protruding from the contact-portion-side surface.

8. The electromagnetic contactor according to claim 7, wherein the protrusion is a second bent portion of the arc runner.

9. The electromagnetic contactor according to claim 1,
wherein the arc runner is configured to function as a heat sink that releases heat generated in the contact portion.

10. An electromagnetic contactor comprising:
a stationary contact element including a stationary contact;
a movable contact element including a movable contact configured to be able to contact and separate from the stationary contact;
an arc-extinguishing chamber that contains a contact portion that includes the stationary contact and the movable contact; and
an arc runner provided in the arc-extinguishing chamber,
wherein the arc-extinguishing chamber includes an insulating wall portion that is situated beside the stationary contact element in a first direction that is a width direction of the stationary contact element,
wherein the arc runner is situated beside the contact portion in a second direction that is perpendicular to the first direction,
wherein the arc runner is fixed to the stationary contact element in a state in which the arc runner stands on the stationary contact element,
wherein a width of the arc runner in the first direction is narrower or equal to a width of the stationary contact element in the first direction, and
wherein the arc runner is a cylindrical and is press-fitted into the surface of the stationary contact element.

11. An electromagnetic contactor comprising:
a stationary contact element including a stationary contact;
a movable contact element including a movable contact configured to be able to contact and separate from the stationary contact;
an arc-extinguishing chamber that contains a contact portion that includes the stationary contact and the movable contact; and
an arc runner provided in the arc-extinguishing chamber,
wherein the arc-extinguishing chamber includes an insulating wall portion that is situated beside the stationary contact element in a first direction that is a width direction of the stationary contact element,
wherein the arc runner is situated beside the contact portion in a second direction that is perpendicular to the first direction, and
wherein the arc runner has a plate shape and is press-fitted into an arc-extinguishing cover that covers the arc-extinguishing chamber.
